(19) United States
(12) Patent Application Publication
(10) Pub. No.: US 2002/0025703 A1
(43) Pub. Date: Feb. 28, 2002

(54) Structure of electric plug

(76) Inventor: Chen-Ta Chen, Hsin Sheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/930,456

(22) Filed: Aug. 16, 2001

(30) Foreign Application Priority Data
Aug. 25, 2000 (CN) 00218978

(51) Int. Cl. H01R 13/44

(52) U.S. Cl. 439/141

(57) ABSTRACT

The present invention proposes an improved structure of electric plug comprising a positioning seat, at least two conducting sheets, at least two springs, at least two insulating sleeves, and a plug body. The insulating sleeves are placed into first slide grooves of the positioning seat. The insulating sleeves have second slide grooves, which are sleeved onto front sides of the conducting sheets, respectively. The positioning seat has first positioning holes connected with the first slide grooves to receive the springs. The positioning seat and the joining portion of rear sides of the conducting sheets and a power code are integrally formed with the plug body by means of mold ejection to be tightly sheathed by the plug body after being assembled and positioned, hence achieving firmer assembling and positioning effect.

### FIELD OF THE INVENTION

The present invention relates to an improved structure of electric plug and, more particularly, to an electric plug having firmer positioning effect.

### BACKGROUND OF THE INVENTION

As shown in FIGS. 1 and 2, China Pat. No. ZL98225631.0 discloses an electric plug comprising a plug body 1, two conducting sheets 2, a positioning seat 5, two insulating sleeves 4, and two springs 6. The two conducting sheets 2 are parallel to each other, and rear sides thereof are connected with a positive wire and a negative wire of a power cord 3, respectively.

The two insulating sleeves 4 have slide grooves 412, which can be sleeved onto front sides 22 of the two conducting sheets 2, respectively. The two insulating sleeves 4 have projective slide blocks 41, which can make reciprocating motion in two slide grooves 51 of the positioning seat 5, respectively.

The width of front sides of the slides grooves 51 of the positioning seat 5 is smaller to prevent the two insulating sleeves 4 from detaching the slide grooves 51 when sliding to front sides 511 of the slide grooves 51. After the insulating sleeves 4 are disposed in the slide grooves 51, the springs 6 are placed therein. Rear ends of the springs 6 can abut against a front end face 11 of the plug body 1.

The front sides 22 of the two conducting sheets 2 can penetrate into he springs 6 and the insulating sleeves 4 disposed in the slide grooves 51 of the positioning seat 5.

When not in use, the two springs 6 in the two slide grooves 51 of the positioning seat 5 provide forward pressure for the two insulating sleeves 4 through front sides 63 thereof to let the two insulating sleeves 4 protrude out of the front sides 511 of the slide grooves 51 and exactly let the front sides 22 of the two conducting sheets 2 not protrude out of front end faces 40 of the insulating sleeves 4, hence preventing from erroneously touching the conducting sheets 2 to achieve higher safety.

When in use, the two insulating sleeves 4 are aligned with insertion holes of a socket and pressed to let the two insulating sleeves 4 simultaneously compress the springs 6, which will slide inwards to expose the two conducting sheets 2. The two conducting sheets 2 can then be plugged into the insertion holes of the socket (not shown).

When the plug body 1 is to be pulled out to detach the two conducting sheets 2 from the insertion holes of the socket, the two springs 6 are exploited to let the two insulating sleeves 4 move forwards so that the front sides 22 of the two conducting sheets 2 can restore to the original state of not protruding out of the insulating sleeves 4.

However, because the front side of the plug body 1 and the positioning seat 5 are joined and fixed by means of supersonic or high-frequency splicing, breakage may easily arise after a period of use if the quality of splicing is not good.

### SUMMARY OF THE INVENTION

The primary object of the present invention is to provide an improved structure of electric plug, wherein a positioning seat and the joining portion of rear sides of conducting sheets and a power cord are integrally formed with a plug body by means of mold ejection to be tightly sheathed by the plug body after being assembled and positioned, hence achieving firmer assembling and positioning effect.

Another object of the present invention is to provide an improved structure of electric plug having insulating sleeves, whose front sides protrude out of a positioning seat. A grounding bar in the insulating sleeves matches at least two conducting sheets so that the present invention can apply to a three-hole socket of a computer or an air conditioner.

To achieve the above objects, the present invention provides an improved structure of electric plug comprising a positioning seat, at least two conducting sheets, at least two springs, at least two insulating sleeves, and a plug body. The positioning seat has at least two first slide grooves. The insulating sleeves are placed in the first slide grooves of the positioning seat. The insulating sleeves have second slide grooves, which are sleeved onto front sides of the conducting sheets. The positioning seat also has first positioning holes connected with the first slide grooves to receive the springs. The plug body is formed by means of mold ejection to sheathe the positioning seat and rear sides of the conducting sheets. An improved structure of electric plug is thus formed.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of a prior art electric plug disclosed in China Pat. No. ZL98225631.0;

FIG. 2 is a perspective view of a prior of a prior art electric plug disclosed in China Pat. No. ZL98225631.0;

FIG. 3 is an exploded perspective view of the present invention (excluding a plug body);

FIG. 4 is a perspective view of the present invention (excluding a plug body);

FIG. 5A is a perspective view of the present invention;

FIG. 5B is another perspective view of the present invention;

FIG. 6 is a cross-sectional view of the present invention;

FIG. 7 is another cross-sectional view of the present invention;

FIG. 8 is a cross-sectional view of the present invention plugged into a socket;

FIG. 9 is another cross-sectional view of the present invention plugged into a socket;

FIG. 10 is yet another cross-sectional view of the present invention plugged into a socket; and

FIG. 11 is an exploded perspective of another embodiment of the present invention (excluding a plug body).

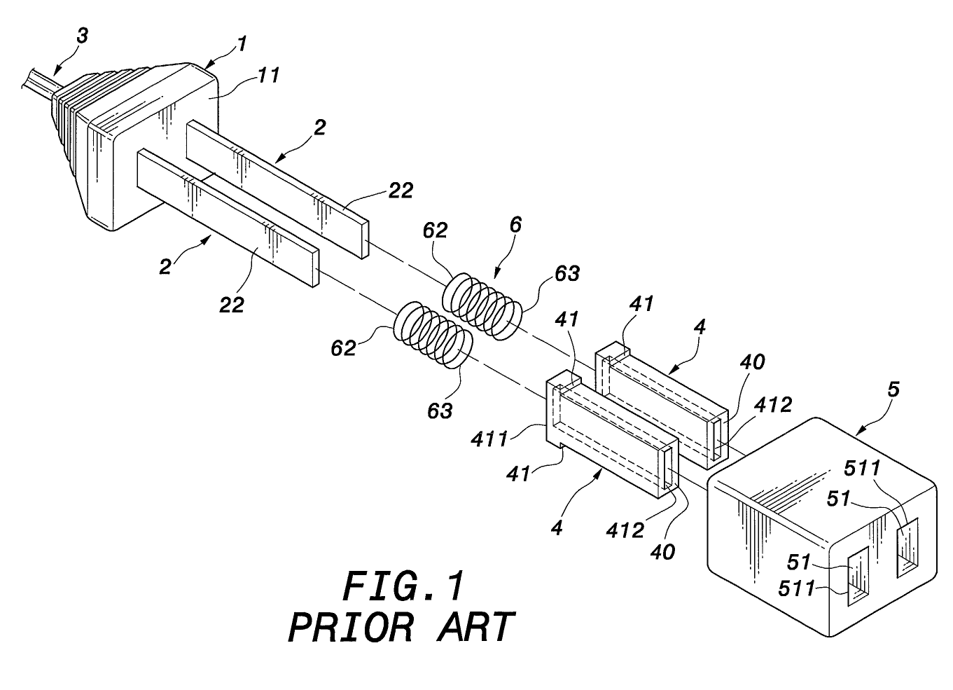

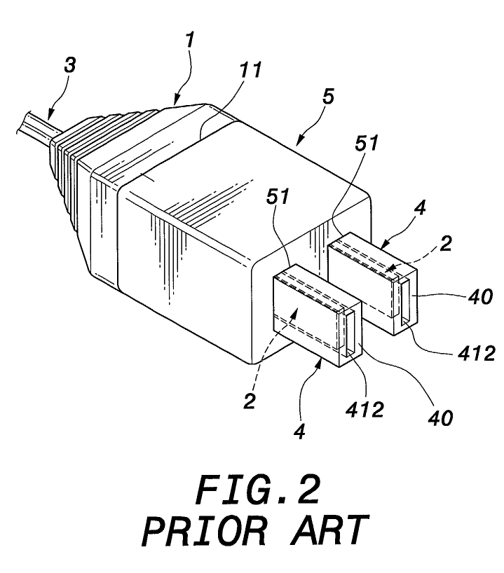

### DETAILED DESCRIPTION OF THE PREFERRED EMBODIMENTS

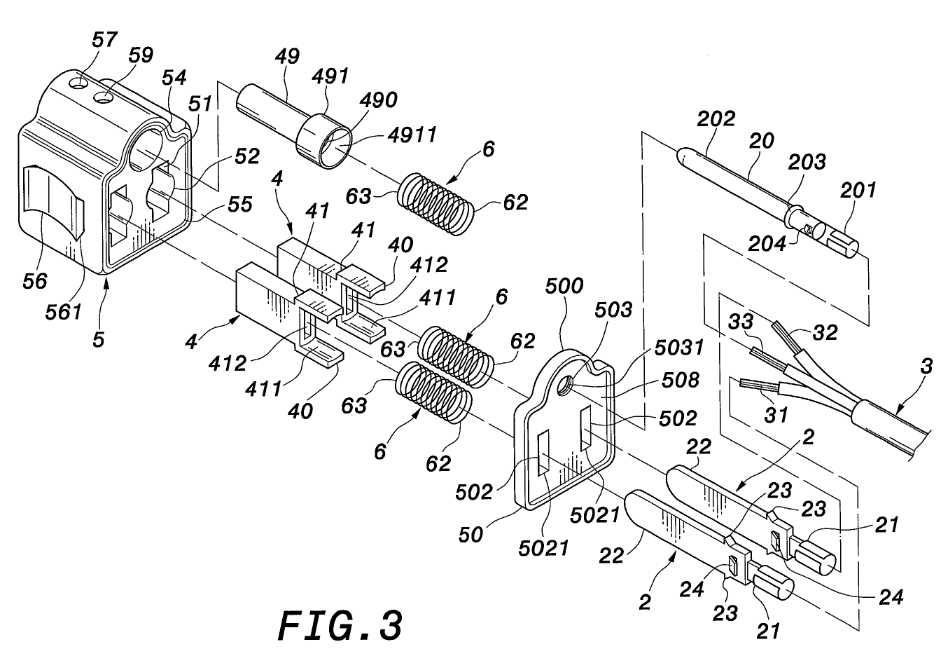

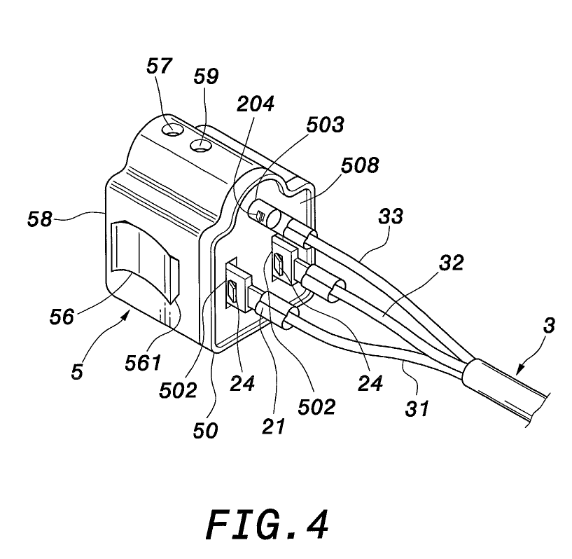

As shown in FIGS. 3 to 10, the present invention provides an improved structure of electric plug comprising a plug body 1, at least two conducting sheets 2, a positioning seat 5, a seat cover 50, a grounding bar 20, at least two insulating sleeves 4, a grounding bar insulating sleeve 49, and at least three springs 6. The conducting sheets 2 are parallel to each other, and rear sides thereof are connected to a positive wire 31 and a negative wire 32 of a power cord 3, respectively. A rear side 201 of the grounding bar 20 is connected to a grounding wire 33 of the power cord 3.

The insulating sleeves 4 have second slide grooves 412, which can be sleeved onto front sides of the conducting sheets 2, respectively. The grounding bar insulating sleeve 49 has a third slide groove 490, which can be sleeved onto the front side of the grounding bar 20. The insulating sleeves 4 and 49 have projective slide blocks 41 and 491 at rear sides thereof, respectively. The insulating sleeves 4 and 49 can make reciprocating motion in first slide grooves 51 and fourth slide grooves 53 of the positioning seat 5, respectively.

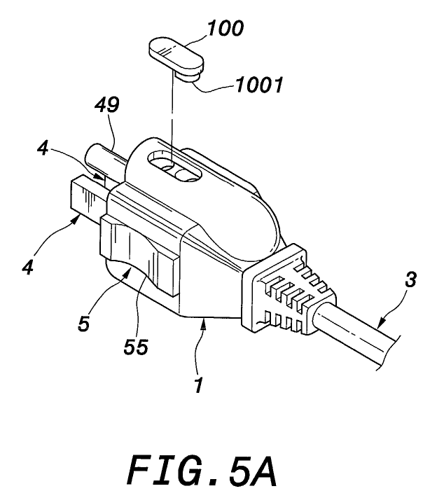

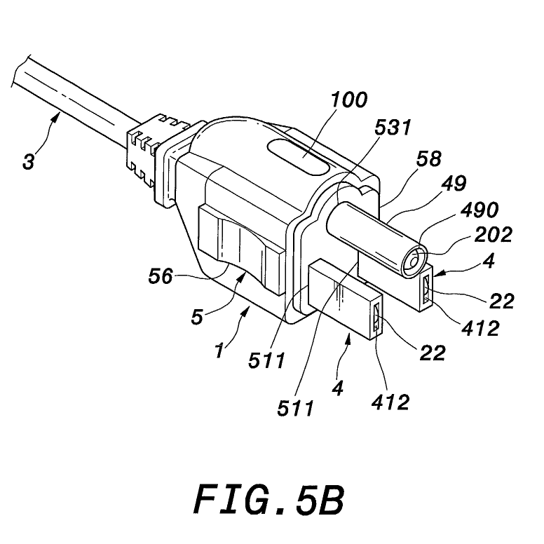

The positioning seat 5 has at least two first slide grooves 51, which have front sides 511 with a smaller width (as shown in FIGS. 5B and 7) to form inner stop portions 512 at two sides thereof for stopping the slide blocks 41 of the insulating sleeves 4, hence preventing the insulating sleeves 4 from detaching the first slide grooves 51 when sliding to the front sides 511 of the first slide grooves 51. The positioning seat 5 also has first positioning holes 52 connected with the first slide grooves 51. The height of the first positioning holes 52 is larger than that of the insulating sleeves 4. After the insulating sleeves 4 are pivotally disposed into the first slide grooves 51, the springs 6 are placed therein.

The seat cover 50 is fixedly disposed at a rear side of the positioning seat 5. The front sides 22 of the conducting sheets 2 can penetrate into the springs 6 disposed in the first positioning holes 52 of the positioning seat 5 and the insulating sleeves 4 disposed in the first slide grooves 51 of the positioning seat 5.

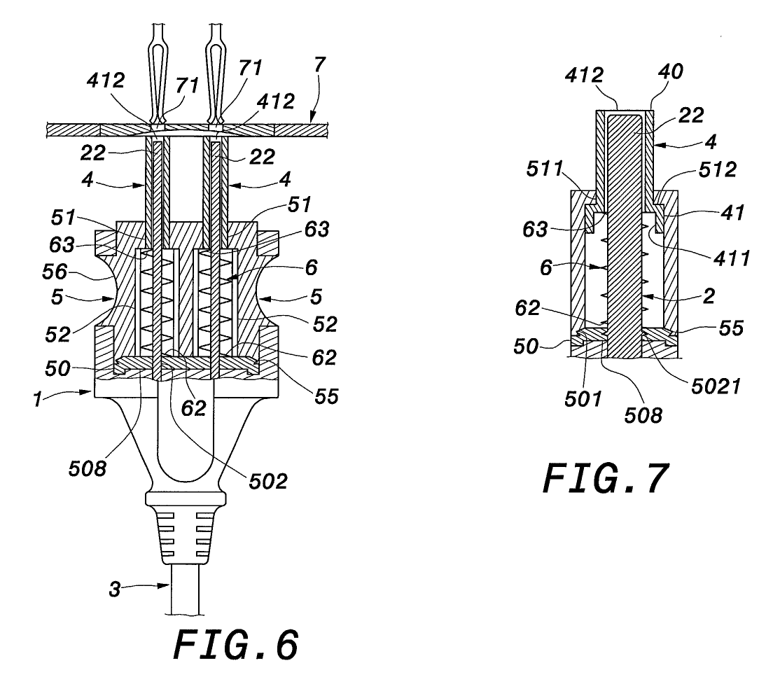

When not in use (as shown in FIGS. 6 and 7), the springs 6 in the first positioning holes 52 of the positioning seat 5 provide forward pressure for the insulating sleeves 4 through the front sides 63 thereof to let the insulating sleeves 4 protrude out of the front sides 511 of the first slide grooves 51 and exactly let the front sides 22 of the conducting sheets 2 not protrude out of the front faces 40 of the insulating sleeves 4, hence preventing from erroneously touching the conducting sheets 2 to achieve higher safety.

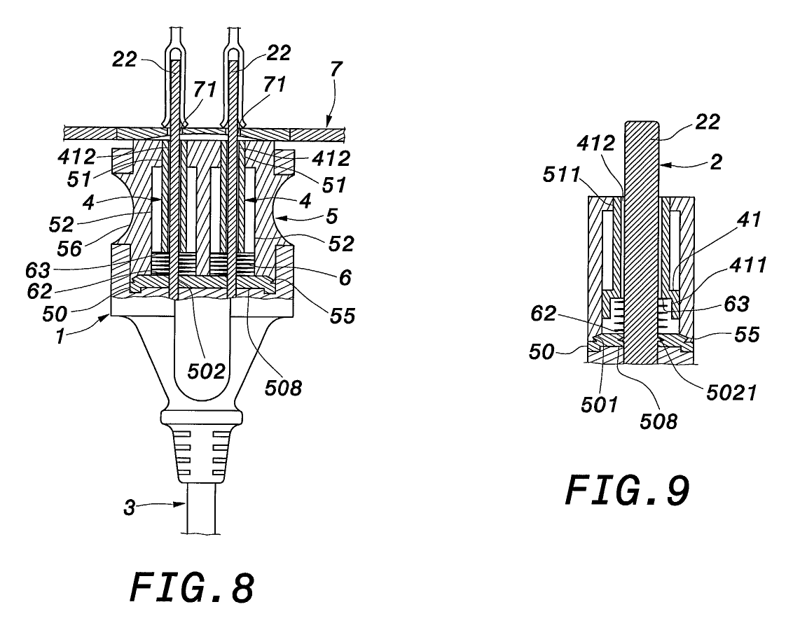

When in use, the insulating sleeves 4 are aligned with insertion holes 71 of a socket 7 and pressed to let the two insulating sleeves 4 simultaneously compress the springs 6, which will slide inwards to expose the two conducting sheets 2. The two conducting sheets 2 can then be plugged into the insertion holes 71 of the socket 7, as shown in FIGS. 8 and 9.

When the plug body 1 is to be pulled out to detach the two conducting sheets 2 from the insertion holes 71 of the socket 7, the two springs 6 are exploited to let the two insulating sleeves 4 move forwards so that the front sides 22 of two conducting sheets 2 can restore to the original state of not protruding out of the insulating sleeves 4, as shown in FIGS. 6 and 7.

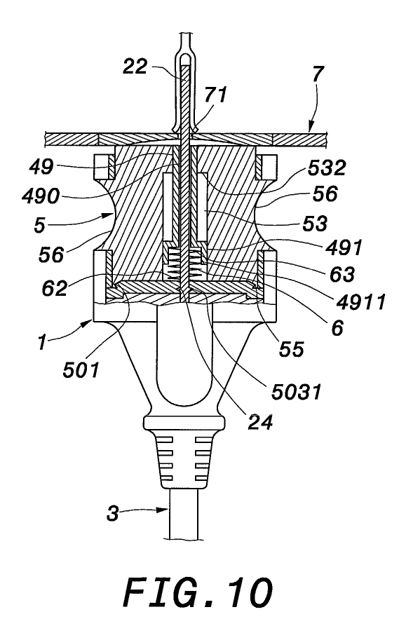

Moreover, the positioning seat 5 has positioning protuberances 56 at two sides thereof and a second positioning hole 57 at a top thereof. A fourth slide groove 53 having a front side 531 with a smaller outer diameter is disposed at the top of the positioning seat 5, as shown in FIG. 10. An inner stop portion 532 is formed in the fourth slide groove 53 to stop a circular stop block 491 of the grounding bar insulating sleeve 49 disposed in the fourth slide groove 53. The positioning seat 5 also has a third positioning hole 54 connected with the fourth slide groove 53 to receive another spring 6, whose front side 63 abuts against a recessed portion 491 at a rear end face of the slide block 491 of the insulating sleeve 49. A retaining groove 55 is also disposed at the rear side of the positioning seat 5 so that a retaining block 501 of the seat cover 5 can be embedded and fixed therein.

The rear end faces of the slide blocks 41 of the insulating sleeves 4 form recessed portions 411 so that the front sides 63 of the springs 6 can be placed therein. The third slide groove 490 of another insulating sleeve 4 forms a circular groove so that the front side 202 of the grounding bar 20 can stick therein. The slide block 491 can let the front side 63 of the spring 6 be placed therein.

The seat cover 50 has a retaining block 501 to be embedded and fixed in the retaining groove 55 at the rear side of the positioning seat 5. The seat cover 50 also has at least two long grooves 502 and a circular groove 503 so that retaining protuberances 23 of the conducting sheets 2 and a retaining protuberances 203 of the grounding bar 20 can be embedded and positioned therein and the rear ends 62 of the springs 6 disposed at the conducting sheets 2 and the grounding bar 2 can exactly abut against an inner end wall face 500 of the cover seat 50. The seat cover 50 also has a recessed portion 508 at a side thereof.

When being assembled, the insulating sleeves 4 and 49 are first placed in the slide grooves 51 and 53 of the positioning seat 5, and the springs 6 are then placed therein. Next, the seat cover 50 and the positioning seat 5 are joined and fixed together. The conducting sheets 2 having the retaining protuberance 23 and the grounding bar 20 having the retaining protuberance 203 then penetrate through the long grooves 502 having the retaining grooves 5021 and the circular groove 503 having the retaining groove 5031 of the seat cover 50 and be positioned, respectively. The conducting sheets 2, the grounding bar 20, the springs 6, the insulating sleeves 4 and 49, the seat cover 50, and the power cord 3 are thus exactly assembled together. Subsequently, an ejection mold and plastic material are placed in to form the plug body 1 sheathing the portions behind the front end face 58 of the positioning seat 5, the seat cover 50, the rear sides 21 of the conducting sheets 2, the rear side of the grounding bar 20, and the front side of the power cord 3 by means of mold ejection.

Because the seat cover 50 has the recessed portion 508, the positioning seat 5 has the positioning protuberances 56 and the second positioning holes 57 at the two sides thereof, and the positioning protuberances 56 have recessed trenches 561, plastic material can be filled in during the mold ejection, thereby achieving firmer sheathing and positioning effect with the plug body 1.

When in use, the insulating sleeves 4 and 49 protruding out of the positioning seat 5 are aligned with insertion holes 71 and 72 of a three-hole socket 7 and pressed to let the insulating sleeves 4 and 49 simultaneously compress the springs 6, which will slide inwards to expose the conducting sheets 2 and the grounding bar 20. The conducting sheets 2 and the grounding bar 20 can then be plugged into the insertion holes 71 and 72 of the socket 7.

When the plug body 1 is to be pulled out, the springs 6 can be exploited to let the insulating sleeves 4 and 49 move forwards so that the conducting sheets 2 and the grounding bar 20 can restore to the original state of not protruding out of the insulating sleeves 4 and 49.

Additionally, the positioning seat 5 has a hole 59 so that an embedding post 1001 of a decorative cover 100 can be embedded therein to enhance decorative effect.

Moreover, the grounding bar 20 can also be a conducting bar to apply to 220-V plugs.

Furthermore, the grounding bar 20 has a projective sheet 204, and the conducting sheets 2 have projective sheets 24. The projective sheets 204 and 24 can be firmly sheathed by plastic material when the plug body 1 is formed by means of mold ejection.

To sum up, the present invention has the following effects.

1. The positioning seat 5, the seat cover 50, the joining portion of the rear sides of the conducting sheets and the power code 3, and the joining portion of the rear side 201 of the grounding bar 20 and the power cord 3 are integrally formed with the plug body 1 by means of mold ejection to be tightly sheathed by the plug body 1 after being assembled and positioned. Therefore, firmer assembling and positioning effect can be achieved.

2. In addition to the two front sides 22 situated in the insulating sleeves 4 and the positive and negative conducting sheets 2 protruding out of the front end face 58 of the positioning seat 5, the insulating sleeve 49 whose front side protruding out of the positioning seat 5 is also provided. The front side 202 of the grounding bar 20 in the insulating sleeve 49 matches the front sides 22 of the conducting sheets 2 to apply to a three-hole socket 7 of a computer or an air conditioner.

3. Because the positioning seat 5 has a protuberance 56 having a recessed trench 561 and a positioning hole 57, and the seat cover 50 has a recessed portion 508 at a side thereof, plastic material can be filled in when the positioning seat 5 is integrally formed with the plug body 1 by means of mold ejection, hence achieving better sheathing and positioning effect.

4. The grounding bar 20 and the conducting sheets 2 have projective sheets 204 and 24, respectively, which can be firmly embedded by plastic material when the plug body 1 is formed by means of mold ejection, hence obtaining better fastening effect.

5. The rear end faces of the insulating sleeves 4 and 49 have recessed portions 411 and 4911, respectively, so that the front sides 63 of the springs 6 can be placed therein, hence better positioning the springs 6 and enhancing accuracy of reciprocating motion of the insulating sleeves 4 and 49.

6. The insulating sleeves 4 and 49 are sleeved onto the conducting sheets 2 and the grounding bar 20 to reduce contact of metal and air, hence achieving waterproof, dustproof, antirust, and anti-oxidation effects, and having better heat-radiating effect.

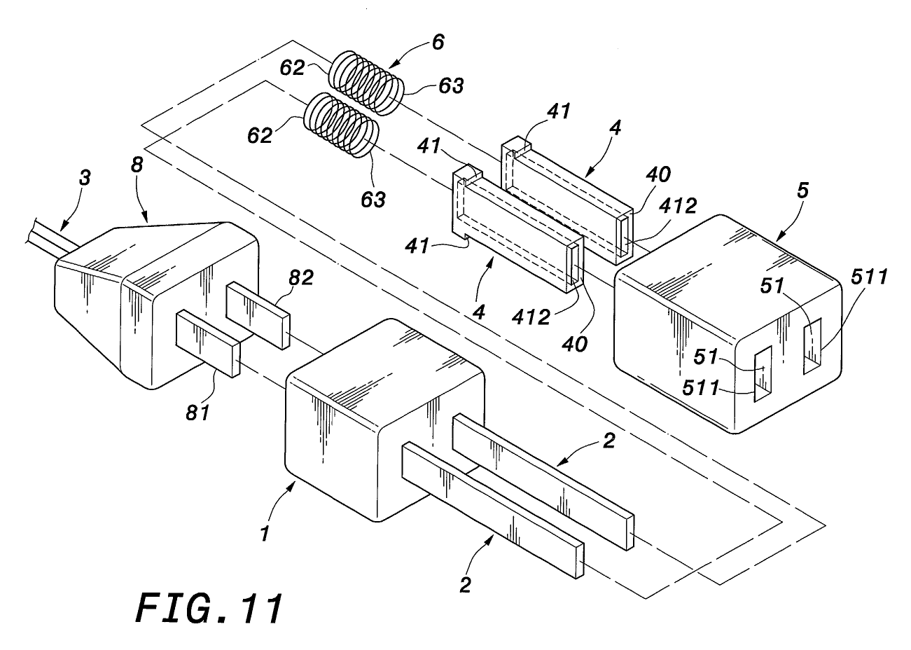

Additionally, as shown in FIG. 11, the shapes and structures of the plug body 1 and the positioning seat 5 of the present invention can vary, and a plug 8 can be disposed between the plug body 1 and the power cord 3. The plug 8 has at least two insertion sheets 81 and 82. Positive and negative wires (not shown) of the power cord 3 are connected to rear sides of the insertion sheets 81 and 82 of the plug 8, and front sides of the insertion sheets 81 and 82 are then connected to the conducting sheets 2 in insertion way.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An improved structure of electric plug, comprising:
a positioning seat having at least two first slide grooves;
at least two conducting sheets;
at least two springs;
at least two insulating sleeves placed into said first slide grooves of said positioning seat, said insulating sleeves having second slide grooves respectively sleeved onto front sides of said conducting sheets, said positioning seat also having first positioning holes connected with said first slide grooves to receive said springs; and
a plug body formed by mean of mold ejection to sheathe rear sides of said positioning seat and said conducting sheets.

2. The improved structure of electric plug as claimed in claim 1, wherein said conducting sheets are parallel to each other, and rear sides thereof are connected to a power cord.

3. The improved structure of electric plug as claimed in claim 1, wherein said insulating sleeves have projective slide blocks at rear sides thereof, and the width of front sides of said first slide grooves of said positioning seat is smaller to form inner stop portions at two sides thereof for stopping said slide blocks of said insulating sleeves.

4. The improved structure of electric plug as claimed in claim 1 further comprising a seat cover, a grounding bar, a grounding bar insulating sleeve, and another spring, a rear side of said grounding bar being connected to a grounding wire of a power cord, said grounding bar insulating sleeve having a third slide groove sleeved onto a front side of said grounding bar, said grounding bar insulating sleeve having a slide block at a rear side thereof, said grounding bar insulating sleeve being placed into a fourth slide groove of said positioning seat, said seat cover being fixedly disposed at a rear side of said positioning seat.

5. The improved structure of electric plug as claimed in claim 4, wherein said seat cover has a retaining block, which can be embedded and fixed in a retaining groove at the rear side of said positioning seat to join and fix said seat cover and said positioning seat, said seat cover also having at least two long grooves and a circular groove so that said conducting sheets having retaining protuberances and said grounding bar having a retaining protuberance can be embedded and positioned therein, rear sides of said springs disposed at said conducting sheets and said grounding bar abutting against an inner end wall face of said seat cover, said seat cover having a recessed portion at a side thereof so that plastic material can be filled therein during mole ejection, said retaining protuberances of said conducting sheets and said grounding bar being capable of penetrating through said long grooves having retaining grooves and said circular groove having a retaining groove to be positioned.

6. The improved structure of electric plug as claimed in claim 4, wherein said positioning seat has positioning protuberances at two sides thereof and a third positioning hole at a top thereof, said positioning protuberances having recessed trenches so that plastic material can be filled therein during mold ejection, said positioning seat having a fourth slide groove whose front side has a smaller outer diameter, an inner stop portion being formed in said fourth slide groove to stop a slide block of said grounding bar insulating disposed in said fourth slide groove, said positioning seat also having a third positioning hole connected with said fourth slide groove to receive said another spring, a front side of said another spring abutting against said recessed portion at a rear end face of said slide block of said insulating sleeve, said positioning seat having a hole so that an embedding post of a decorative cover can be embedded therein.

7. The improved structure of electric plug as claimed in claim 1 further comprising a plug having at least two insertion sheets, said insertion sheets of said plug being connected to a power cord, said insertion sheets of said plug being connected to said conducting sheets in insertion way.
